(19) United States
(12) Patent Application Publication
(10) Pub. No.: US 2008/0164829 A1
(43) Pub. Date: Jul. 10, 2008

(54) POWER SUPPLY DEVICE FOR LUMINOUS ELEMENT AND METHOD THEREOF

(75) Inventors: Sang-hoon LEE, Ulsan (KR); Jeong-il KANG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/773,597

(22) Filed: Jul. 5, 2007

(30) Foreign Application Priority Data
Jan. 8, 2007 (KR) 2007-2201

(51) Int. Cl. H05B 41/36

(52) U.S. Cl. 315/308

(57) ABSTRACT

A power supply device for a luminous element and a method thereof are provided. The power supply device includes an output calculation unit for calculating a brightness level of the luminous element, a current command signal generation unit for generating a current command signal so that a current value being supplied to the luminous element is adjusted by stages, and a constant current source for adjusting by stages the current being supplied to the luminous element according to the current command signal. According to the power supply device, the ascending period and the descending period can be shortened, and light output characteristics can be improved by improving the transient characteristic through an adaptive adjustment of current in the ascending period and the descending period.

### CROSS-REFERENCE TO RELATED APPLICATIONS

This application claims the benefit of Korean Patent Application No. 10-2007-0002201, filed Jan. 8, 2007, in the Korean Intellectual Property Office, the entire disclosure of which is incorporated herein by reference.

### BACKGROUND OF THE INVENTION

1. Field of the Invention

Apparatuses and methods consistent with the present invention relate to a power supply device for a luminous element. More particularly, the present invention relates to a power supply device for a luminous element and a method thereof, which can improve the luminous characteristics.

2. Description of the Related Art

A solid-state semiconductor luminous element is an element that converts electricity into light; representative luminous elements are a light-emitting diode, a semiconductor laser (laser diode (LD)), and so forth.

The solid-state semiconductor luminous element receives power supplied from a constant current source. A power supply device of the solid-state semiconductor luminous element calculates the lighting time and brightness of the luminous element, and applies a control signal for commanding the constant current source to output a current corresponding to the brightness of the solid-state semiconductor luminous element.

FIGS. 1A and 1B are waveform diagrams of signals through a power supply device of a conventional solid-state semiconductor luminous device.

In FIG. 1A, waveforms of a period signal having a first brightness level, a control signal, and an output current are illustrated in order. If a signal is input, the power supply device generates a period signal by calculating the lighting time and the non-lighting time of the luminous element, and generates a control signal for outputting current of a first level that corresponds to the first brightness level. When the period signal and the control signal are supplied to the constant current source, the constant current source outputs current corresponding to the first brightness level for the lighting time.

In this case, if the current of the first level that corresponds to the first brightness level is input to the luminous element, the output current of the luminous element ascends for a specified ascending period and reaches the output current that corresponds to the first brightness level. If the current being supplied to the luminous element is cut off to turn off the luminous element, the output current of the luminous element descends for a specified descending period and then reaches the output current of the level “0”, so that the luminous element is turned off.

In FIG. 1B, waveforms of a period signal having a second brightness level that is lower than the first brightness level, a control signal, and an output current are illustrated in order.

If a signal is input, a control signal for outputting a period signal and current of a second level is generated, and the period signal and the control signal are supplied to the constant current source. If the current of the second level that corresponds to the second brightness is input to the luminous element, the output current of the luminous element ascends for a specified ascending period and reaches the output current that corresponds to the second brightness. If the current being supplied to the luminous element is cut off to turn off the luminous element, the output current of the luminous element descends for a specified descending period and then reaches the output current of the level “0”.

As described above, the conventional power supply device generates the control signal in the same manner irrespective of the brightness of the luminous element, and adjusts the current value being supplied to the luminous element according to the control signal.

In order to maximize the light efficiency of the luminous element in the conventional luminous element power supply device, it is required to shorten the ascending period and the descending period and to shorten the stabilization time after the output current reaches the current value that corresponds to the specified brightness. For this, an inductor having a small inductance value is used to shorten the ascending period and the descending period.

However, if the ascending period or the descending period becomes shortened, overshoot that corresponds to the abruptly increasing current may occur. This transient response damages the linearity of the light output. In order to prevent the overshoot that damages the linearity of the light output, an inductor having a large inductance value can be used to slowly ascend the current. However, the inductor having a large inductance value extends the ascending period and the descending period. Consequently, when the inductor having a small inductance value is used, overshoot occurs, while when the inductor having a large inductance value is used, the ascending period or the descending period is lengthened.

### SUMMARY OF THE INVENTION

Exemplary embodiments of the present invention have been provided to address at least the above problems and/or disadvantages, and to provide at least the advantages described below. Accordingly, an exemplary aspect of embodiments of the present invention is to provide a power supply device for a luminous element and a method thereof, which can prevent the occurrence of overshoot during lighting of the luminous element and reduce an ascending period and a descending period of current output to the luminous element.

The foregoing and other objects and advantages are substantially realized by providing a power supply device for a luminous element, according to embodiments of the present invention, which comprises an output calculation unit for calculating a brightness level of the luminous element; a current command signal generation unit for generating a current command signal so that a current value being supplied to the luminous element is adjusted by stages; and a constant current source for adjusting by stages the current being supplied to the luminous element according to the current command signal.

The current command signal generation unit may generate the current command signal so that the current being supplied from the constant current source is linearly increased with a predetermined slope during lighting of the luminous element.

The current command signal generation unit may generate the current command signal so that the current being supplied from the constant current source is exponentially increased during lighting of the luminous element.

The current command signal generation unit may generate the current command signal so that the current being supplied from the constant current source is linearly increased with a plurality of slopes during lighting of the luminous element.

The current command signal generation unit may generate the current command signal so that the slope of a current value being supplied to the luminous element in a predetermined initial period set from a time point of starting the lighting of the luminous element is different from the slope of a current value being supplied to the luminous element in the remaining period in which the current reaches a current value that corresponds to the brightness level.

The slope of the current command signal in the initial period may be greater than the slope of the current command signal in the remaining period.

The current command signal generation unit may generate the current command signal so that the current being supplied from the constant current source has a negative value during lighting of the luminous element.

The current command signal generation unit may generate the current command signal so that the current value which is higher than the current value that corresponds to the brightness level is supplied during lighting of the luminous element.

According to another aspect of embodiments of the present invention, there is provided a power supply method for a luminous element, which comprises calculating a brightness level of the luminous element; generating a current command signal so that the level of current being supplied to reach the brightness level is adjusted by stages; and adjusting by stages the current being supplied to the luminous element according to the current command signal.

### BRIEF DESCRIPTION OF THE DRAWINGS

The above and other aspects and features of the present invention will become more apparent by describing certain exemplary embodiments of the present invention with reference to the accompanying drawings, in which:

FIGS. 1A and 1B are waveform diagrams of signals through a power supply device of a conventional solid-state semiconductor luminous device;

FIG. 2 is a block diagram illustrating the construction of a power supply device for a luminous element according to an exemplary embodiment of the present invention;

FIG. 3 is a waveform diagram of a period signal output from an output calculation unit, a current command signal generation unit, a constant current source, a current command signal, and an output current, according to a first embodiment of the present invention;

FIG. 4 is a waveform diagram of a period signal output from an output calculation unit, a current command signal generation unit, a constant current source, a current command signal, and an output current, according to a second embodiment of the present invention;

FIG. 5 is a waveform diagram of a period signal output from an output calculation unit, a current command signal generation unit, a constant current source, a current command signal, and an output current, according to a third embodiment of the present invention; and

FIG. 6 is a waveform diagram of a period signal output from an output calculation unit, a current command signal generation unit, a constant current source, a current command signal, and an output current, according to a fourth embodiment of the present invention.

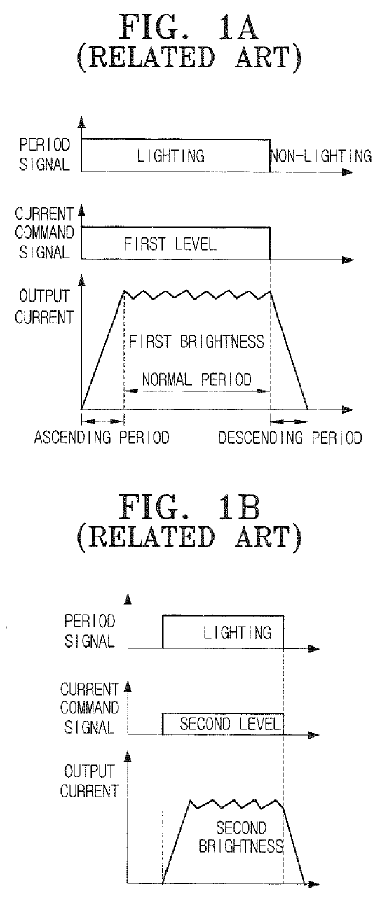

Throughout the drawings, the same drawing reference numerals will be understood to refer to the same elements, features and structures.

### DETAILED DESCRIPTION OF EXEMPLARY EMBODIMENTS

Certain exemplary embodiments of the present invention will now be described in greater detail with reference to the accompanying drawings.

The matters defined in the description, such as detailed constructions and elements, are provided to assist in a comprehensive understanding of the embodiments of the present invention and are merely exemplary. Accordingly, those of ordinary skill in the art will recognize that various changes and modifications of the exemplary embodiments described herein can be made without departing from the scope and spirit of the present invention. Descriptions of well-known functions and constructions are omitted for clarity and conciseness.

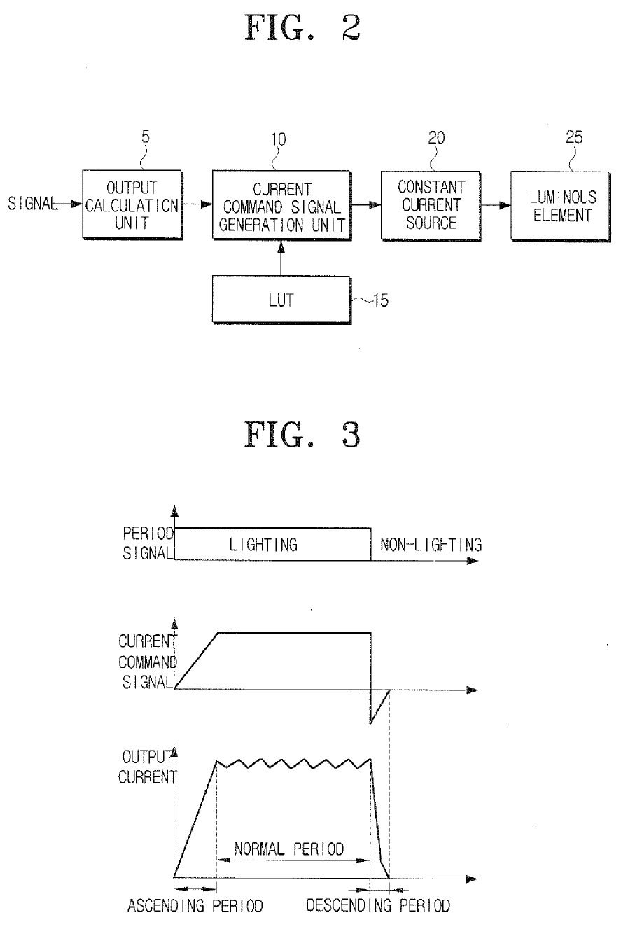

FIG. 2 is a block diagram illustrating the construction of a power supply device for a luminous element according to an exemplary embodiment of the present invention.

Referring to FIG. 2, the power supply device for a luminous element according to an exemplary embodiment of the present invention comprises an output calculation unit 5, a current command signal generation unit 10, a constant current source 20, a lookup table 15, and a luminous element 25.

The output calculation unit 5 outputs a period signal by measuring a lighting time and a non-lighting time of the luminous element 25 by processing an input signal, and calculates a brightness level of the luminous element 25. At this time, the brightness level is divided into a plurality of levels in accordance with the level of an input signal. In the exemplary embodiment of the present invention, the brightness level is divided into a first brightness level and a second brightness level.

The current command signal generation unit 10 generates a current command signal for commanding a current value being supplied to the luminous element 25 for an ascending period, a normal period, and a descending period, in accordance with the brightness level calculated by the output calculation unit 5. At this time, the current command signal generation unit 10 can adjust the widths of the ascending period and the descending period and prevent overshoot by generating the current command signal so that the current value being applied during the ascending period and the descending period becomes different from a normal current value being applied during the normal period. Here, the normal period means a period in which the brightness of the luminous element 25 reaches a desired brightness level and is maintained, and the normal current value means a current value output from the constant current source 20 during the normal period.

In the first to fourth embodiments of the present invention to be described later, the current command signal generation unit 10 generates the current command signal in diverse methods. In the first embodiment of the present invention, the current command signal generation unit 10 generates a current command signal that is linearly increased to the current command signal indicating the normal current value during the ascending period, and generates a current command signal that indicates a negative current value during the descending period. In the second embodiment of the present invention, the current command signal generation unit 10 generates a current command signal that is linearly increased with two slopes during the ascending period. In the third embodiment of the present invention, the current command signal generation unit generates a current command signal so that a current value that is higher than the normal current value can be supplied when the brightness value of the luminous element is a second brightness value. In the fourth embodiment of the present invention, the current command signal generation unit 10 generates a current command signal so that the current value is exponentially increased during the ascending period and the descending period. A detailed description thereof will be made later with reference to FIGS. 3 to 6.

The current command signal generation unit 10 may generate the current command signal whenever the brightness level is determined due to the input signal, or obtain the current command signal corresponding to the brightness level from a lookup table 15, in which current values for brightness levels are pre-stored, to provide the current command signal to the constant current source 20.

Stored in the lookup table 15 are brightness levels, a current command signal that is provided to the constant current source 20 during the ascending period, a current command signal that is provided to the constant current source 20 during the normal period, and a current command signal that is provided to the constant current source 20 during the descending period. In this case, the respective current command signals are stored in accordance with the brightness levels, and thus if a brightness level is calculated by the output calculation unit 5, the current command signal generation unit 10 can immediately retrieve the current that is supplied to the constant current source 20 during the ascending period, the normal period, or the descending period, using the lookup table 15.

The constant current source 20 generates the current so that the current value corresponds to the current command signal generated by the current command signal generation unit 10, and provides the generated current to the luminous element 25.

FIG. 3 is a waveform diagram of a period signal output from the output calculation unit 5, the current command signal generation unit 10, the constant current source 20, a current command signal, and an output current, according to the first embodiment of the present invention. In the first embodiment of the present invention, the brightness level is exemplified by the first brightness level.

If a signal is input, the output calculation unit 5 generates a period signal that appears in the first waveform diagram by calculating the lighting time period and the non-lighting time period of the luminous element 25. Also, the output calculation unit 5 calculates the brightness level of the luminous element 25.

The current command signal generation unit 10 generates, or draws from the lookup table 15, the current command signals corresponding to the ascending period, the normal period, and the descending period, to light the luminous element 25 at the first brightness level.

The current command signal generation unit 10, as shown in the second waveform diagram, generates the current command signal in the ascending period so that the current command signal is linearly increased until it reaches the current command signal that indicates the normal current value. In this case, the current command signal generation unit 10 makes the current command signal linearly increase in the ascending period for a predetermined time.

As the current command signal generation unit 10 linearly increases the current command signal during the ascending period, the output current being supplied to the luminous element 25 is linearly increased during the ascending period as shown in the third waveform diagram. If the output current is linearly increased as described above, overshoot occurring due to an abrupt increase of the current being supplied to the luminous element 25 can be prevented.

During the descending period, the current command signal generation unit 10 generates the current command signal so that a negative output current is output, and then generates the current command signal so that the output current gradually becomes “0”. Accordingly, the output current being supplied to the luminous element 25 is abruptly lowered to a negative level during the descending period, and thus the descending period can be shortened.

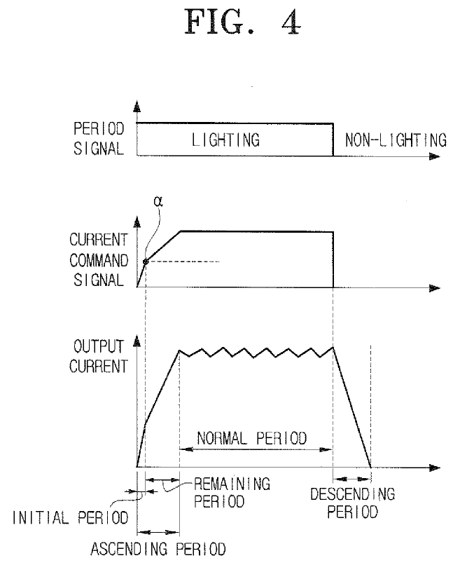

FIG. 4 is a waveform diagram of a period signal output from the output calculation unit 5, the current command signal generation unit 10, the constant current source 20, a current command signal, and an output current, according to the second embodiment of the present invention. In the second embodiment of the present invention, the brightness level is exemplified by the first brightness level.

The output calculation unit 5 generates a period signal as shown in the first waveform diagram by calculating the lighting time period and the non-lighting time period of the luminous element 25, and calculates the brightness level of the luminous element 25.

In order to light the luminous element at the first brightness level, the current command signal generation unit 10 generates the current command signal so that the current value linearly increases until it reaches the normal current value in the ascending period. At this time, the current command signal generation unit 10 forms an inflection point a so that the current command signal has more than one slope. That is, as shown in the second waveform diagram, the current command signal generation unit 10 makes the current command signal have a sharp slope so that the current command signal is sharply increased in an initial period of the ascending period, and then makes the current command signal have a gentle slope so that the current command signal gently increases in the remaining period of the ascending period.

In FIG. 4, the ascending period is divided into an initial period and a remaining period. However, the ascending period may be divided into two or more initial periods and remaining periods.

As the current command signal generation unit 10 linearly increases the current command signal with the inflection point a given thereto, the output current being output from the luminous element 25 is linearly increased with the inflection point a given thereto, as shown in the third waveform diagram. Accordingly, the current value being supplied to the luminous element 25 is abruptly increased in the initial period of the ascending period, and then is gently increased in the remaining period of the ascending period, so that the ascending period can be shortened and overshoot can be prevented.

In the second embodiment of the present invention, the current command signal is generated so that the current of the level “0” is output from the constant current source 20 in the descending period. However, in the same manner as the first embodiment of the present invention, the current command signal may be generated so that a negative current level is first supplied to the luminous element 25, and then current at the level “0” is supplied to the luminous element 25.

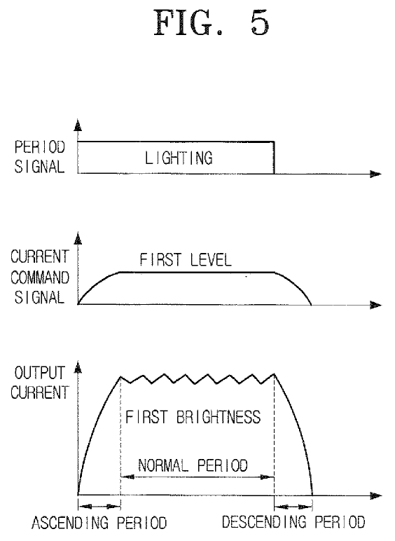

FIG. 5 is a waveform diagram of a period signal output from the output calculation unit 5, the current command signal generation unit 10, the constant current source 20, a current command signal, and an output current, according to the third embodiment of the present invention. In the third embodiment of the present invention, the brightness level is exemplified by the second brightness level.

The output calculation unit 5 generates a period signal as shown in the first waveform diagram in accordance with the input signal, and calculates and supplies the brightness level to the current command signal generation unit 10.

The current command signal generation unit 10 generates the current command signal for outputting the normal current value of the first level that corresponds to the brightness level in the same manner as the conventional power supply device. However, the current command signal generation unit 10 according to the present invention further comprises an analog circuit for exponentially changing the current command signal. In an exemplary embodiment, the current command signal is changed according to an exponential function, e.g., with a decreasing slope, or in a logarithmic manner. The analog circuit is composed of an RC circuit that exponentially changes the input signal, and as the current command signal is exponentially changed, as shown in the second waveform diagram, the current value is exponentially changed in the ascending period and the descending period, as shown in the third waveform diagram.

The time constant of the RC circuit is changed according to the values of a resistor and a capacitor. Thus, by adjusting the values of the resistor and the capacitor in the RC circuit, the time required for the current command signal to reach the current command signal corresponding to the normal current can be adjusted.

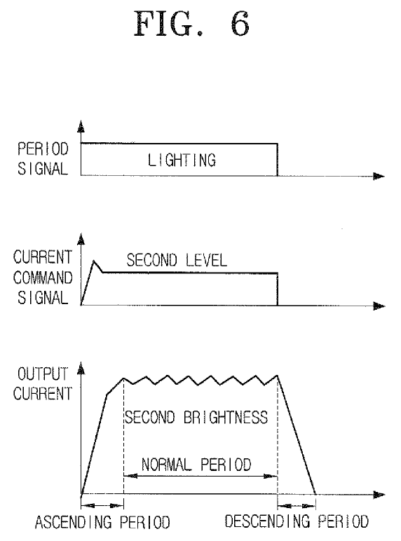

FIG. 6 is a waveform diagram of a period signal output from the output calculation unit 5, the current command signal generation unit 10, the constant current source 20, a current command signal, and an output current, according to the fourth embodiment of the present invention. In the fourth embodiment of the present invention, the brightness level is exemplified by the second brightness level.

The output calculation unit 5 generates a period signal as shown in the first waveform diagram, and calculates the second brightness level of the luminous element.

As shown in the second waveform diagram, the current command signal generation unit 10 generates the current command signal so that the current command signal has a sharp slope in the initial period of the ascending period, and a current value that is larger than the normal current value of the second level is supplied to the luminous element 25. Then, in the remaining period of the ascending period, the current command signal generation unit 10 generates the current command signal so that the current value is decreased to the normal current value. In the case where the normal current value is small, as in the second brightness value, the current value is rather gently increased, and thus the time when the current value reaches the normal current value may be lengthened. In this case, by generating the current command signal so that a current value that is larger than the normal current value is supplied, the ascending period in which the output current reaches the normal current value can be shortened, as shown in the third waveform diagram.

In the fourth embodiment of the present invention, the current command signal is generated so that a current at the level “0” is output from the constant current source 20 in the descending period. However, in the same manner as the first embodiment, the descending time may be further shortened by providing a current command signal of a negative current level.

A process of turning on/off the luminous element 25 by using the power supply device for the luminous element 25 as constructed above will now be described.

If a signal is input, the output calculation unit 5 generates and provides the brightness level and the period signal to the current command signal generation unit 10. The current command signal generation unit 10 generates the current command signal in the ascending period and the descending period in accordance with the brightness level. If the brightness level is the first level, the current command signal generation unit 10 generates the current command signal in the ascending period and the descending period by using the method as described in the first to third embodiments of the present invention, while if the brightness level is the second level, the current command signal generation unit 10 generates the current command signal in the ascending period and the descending period by using the method as described in the first to fourth embodiments of the present invention.

The generated current command signal is provided to the constant current source 20, and the constant current source 20 adjusts the current value in the ascending period and the descending period in accordance with the current command signal, and supplies the adjusted current to the luminous element 25.

The power supply device according to the present invention can prevent the occurrence of overshoot by making the current value gently increase in the ascending period, if the brightness level is higher than the normal current value. Also, the power supply device applies a current value that is higher than the normal current value in the ascending period, if the brightness level is lower than the normal current value, while it applies a negative current value in the descending period, so that the ascending period and the descending period can be shortened.

As described above, according to the present invention, the ascending period and the descending period can be shortened by adopting an inductor having a low inductance value, and the occurrence of overshoot can be prevented by gently increasing the current value in the ascending period.

The foregoing embodiments and advantages are merely exemplary and are not to be construed as limiting the present invention. The present teaching can be readily applied to other types of apparatuses. The description of the exemplary embodiments of the present invention is intended to be illustrative, and not to limit the scope of the claims. Many alternatives, modifications, and variations will be apparent to those skilled in the art.

What is claimed is:

1. A power supply device for a luminous element, comprising:
an output calculation unit which calculates a brightness level of the luminous element;
a current command signal generation unit which generates a current command signal to adjust a current value being supplied to the luminous element; and
a constant current source which adjusts by stages the current being supplied to the luminous element, according to the current command signal.

2. The power supply device of claim 1, wherein the current command signal generation unit is configured to generate the current command signal so that the current being supplied to the luminous element from the constant current source is linearly increased with a predetermined slope during lighting of the luminous element.

3. The power supply device of claim 1, wherein the current command signal generation unit is configured to generate the current command signal so that the current being supplied to the luminous element from the constant current source is increased according to an exponential function during lighting of the luminous element.

4. The power supply device of claim 1, wherein the current command signal generation unit is configured to generate the current command signal so that the current being supplied to the luminous element from the constant current source is linearly increased with a plurality of slopes during lighting of the luminous element.

5. The power supply device of claim 1, wherein the current command signal generation unit is configured to generate the current command signal so that a slope of a current value being supplied to the luminous element in a predetermined initial period set from a time point of starting the lighting of the luminous element, is different from a slope of a current value being supplied to the luminous element in a remaining period in which the current reaches a current value that corresponds to the brightness level.

6. The power supply device of claim 5, wherein the slope of the current command signal in the initial period is greater than the slope of the current command signal in the remaining period.

7. The power supply device of claim 1, wherein the current command signal generation unit is configured to generate the current command signal to have a negative value so that the current being supplied from the constant current source has a value of “0” during dimming of the luminous element.

8. The power supply device of claim 1, wherein the current command signal generation unit is configured to generate the current command signal so that a current value which is higher than the current value that corresponds to the brightness level is supplied to the luminous element during lighting of the luminous element if the brightness level of the luminous element is less than a specified value.

9. A power supply method for a luminous element, comprising:
calculating a brightness level of the luminous element;
generating a current command signal to adjust a level of current being supplied to the luminous element; and
adjusting by stages the current being supplied to the luminous element according to the current command signal.

10. The power supply method of claim 9, wherein the generating the current command signal comprises generating the current command signal so that the current is linearly increased with a predetermined slope during lighting of the luminous element.

11. The power supply method of claim 9, wherein the generating the current command signal comprises generating the current command signal so that the current is increased according to an exponential function during lighting of the luminous element.

12. The power supply method of claim 9, wherein the generating the current command signal comprises generating the current command signal so that the current is linearly increased with a plurality of slopes during lighting of the luminous element.

13. The power supply method of claim 10, wherein the step of generating the current command signal comprises:
generating the current command signal so that a current value is linearly increased with a specified slope in an initial period set from a time point of starting the lighting of the luminous element; and
generating the current command signal so that the current value has a slope, which is different from the slope of the current value in the initial period, in a remaining period in which the current reaches the current value that corresponds to the brightness level.

14. The power supply method of claim 13, wherein the slope of the increasing current command signal in the initial period is greater than the slope of the increasing current command signal in the remaining period.

15. The power supply method of claim 9, further comprising generating the current command signal to have a negative value so that the current has a value of “0” during dimming of the luminous element.

16. The power supply method of claim 9, wherein the step of generating the current command signal comprises generating the current command signal so that a current value which is higher than the current value that corresponds to the brightness level is supplied to the luminous element during lighting of the luminous element if the brightness level of the luminous element is less than a specified value.
